(19) United States
(12) Patent Application Publication
(10) Pub. No.: US 2018/0077190 A1
(43) Pub. Date: Mar. 15, 2018

(54) CLOUD-BASED THREAT OBSERVATION SYSTEM AND METHODS OF USE

(71) Applicant: WHOA Networks, Inc., Hollywood, FL (US)

(72) Inventors: Brock Mowry, Davie, FL (US); Mark Amarant, Davie, FL (US)

(73) Assignee: WHOA Networks, Inc., Hollywood, FL (US)

(21) Appl. No.: 15/664,771

(22) Filed: Jul. 31, 2017

Related U.S. Application Data
(60) Provisional application No. 62/385,370, filed on Sep. 9, 2016.

(51) Int. Cl. H04L 29/06; G06F 17/30

(52) U.S. Cl. CPC H04L 63/1433; G06F 17/30554; H04L 63/1416; H04L 63/0245

(57) ABSTRACT

A computer program that is executable on a user device and operable to display information on a user display, the computer program being configured to transmit a threat data request, receive formatted data, parse the formatted data, defining parsed formatted data, create display information from the parsed formatted data, create at least one of a graph and a widget comprising a datum of the parsed formatted data, create a threat observing world map comprising a datum of the parsed formatted data, and display the threat observing world map on the user display.

### RELATED APPLICATIONS

This application claims the benefit under 35 U.S.C. § 119(e) of U.S. Provisional Patent Application Serial No. 62/385,370 filed on Sep. 9, 2016 and titled Cloud-Based Threat Observation System and Method of Use, the entire content of which is incorporated herein by reference.

### FIELD OF THE INVENTION

The present invention relates generally to the field of cloud computing and, more specifically, to systems and methods for securing cloud services, applications, platforms, and infrastructure.

### BACKGROUND

Cloud computing is an emerging technology in the information technology (IT) industry. Cloud computing allows for the moving of applications, services, and data from desktop computers back to a main server farm. The server farm may be off premises and may be implemented as a service. By relocating the execution of applications, deployment of services, and storage of data, cloud computing offers a systematic way to manage costs of open systems, centralize information, and enhance robustness and reduce energy costs.

Intrusion detection is the practice of identifying inappropriate, unauthorized, or malicious activity in computer systems. Systems designed for intrusion detection typically monitor for security breaches perpetrated by external attackers as well as by insiders using the computer system or a computer network. As computer systems become increasingly interconnected through networking, and particularly through the cloud computing model, intruders and attackers are provided with greater opportunities for gaining unauthorized access while avoiding detection. As a result of widespread cooperative use of shared computing resources, for example in corporate network environments, intrusion detection systems (IDS) are commonly tasked with monitoring complex system organizations and detecting intrusions to network segments including multiple computing machines and/or devices.

In order to detect such intrusion attempts, some existing implementations of IDS install a host-based sensor at each of the machines within the network to be monitored. Such host-based intrusion detection system (HIDS) sensors are typically loaded in software onto a host system such as a computer to monitor the traffic (some of which may be encrypted) going in and out of the host. Anomalous traffic patterns or known attack signatures could signal an external attack on the host, an unauthorized use originating from the host, or an internal attack originating from an infected or otherwise compromised host. Some HIDS sensors may also monitor files and processes internal to the host system to watch for suspicious use of the host itself. If known suspicious activity is detected at the host, some HIDS will typically generate an alert to be sent throughout the network as a notification of a detected intrusion.

Other existing forms of IDS focus monitoring on an entire network segment rather than on individual hosts. Such network-based intrusion detection systems (NIDS) are typically installed as physical devices positioned at locations within the network where they can monitor all network traffic entering and exiting the network segment. For example, a NIDS sensor is often implemented as a physical NIDS device placed just behind a firewall protecting a network segment, such that all traffic going in and out of the network segment must pass through and be scanned by the NIDS. The NIDS typically operates at the lower layers of the protocol stack to watch for suspicious network traffic patterns such as connection attempts to known frequently attacked ports, anomalous combinations in packet headers, and known attack signature patterns in unencrypted packets.

In addition to intrusion detection, some network security systems also incorporate intrusion protection systems (IPS) which are capable of reacting to detected security breaches to protect the network. For example, a network-based IPS could drop suspicious unencrypted packets or block a suspected intruder from communicating with the network. A host-based IPS could prevent unauthorized changes to files or code residing on the host system, and could deny access to the host by suspicious users or applications. Such combined Intrusion Detection and Prevention Systems (IDPS) include anti-virus systems that typically record information related to observed events, notify security administrators of important observed events, and produce reports. Antivirus software is used to prevent, detect, and remove malware, including, but not limited to, computer viruses, computer worms, Trojan horses, spyware and adware. Computer security, including protection from social engineering techniques, is commonly offered in products and services of antivirus software companies. Antivirus techniques are based on signature-based detection, heuristic-based detection and file emulation.

An IDPS may respond to a detected threat by attempting to prevent it from succeeding. It may use several response techniques which involve stopping the attack itself, changing the security environment (e.g., reconfiguring a firewall), or changing the attack's content. An IDPS may take some action to avoid or restrict external access of computer systems upon suspicion or detection of a system or device intrusion or breach, for example blocking network ports, restricting system policies, etc. An ISPS may also alert an administrator (“admin”) as to a suspected intrusion or breach, wherein the admin is expected to take application-specific action in response, for example, to restrict file system level policies, etc.

While certain aspects of conventional technologies have been discussed to facilitate disclosure of the invention, the applicant in no way disclaims these technical aspects, and it is contemplated that the claimed invention may encompass one or more of the conventional technical aspects discussed herein. The present invention may address one or more of the problems and deficiencies of the current availability and prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein, or limited to the particular embodiment for the invention used to illustrate the steps and functionality of the herein.

This background information is provided to reveal information believed by the applicant to be of possible relevance to the present invention. No admission is necessarily intended, nor should be construed, that any of the preceding information constitutes prior art against the present invention. This reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### SUMMARY OF THE INVENTION

With the above in mind, embodiments of the present invention are related to a method for identifying intrusions to a computing system comprising executing a firewall service comprising detecting an access request comprising an Internet Protocol (IP) packet to the computing system and determining if the IP packet comprises a signature matching a threat signature. Upon determining the IP packet does not comprise a signature matching a threat signature, the IP packet may be permitted to transit to a target client associated with the IP packet. Upon determining the IP packet comprises a signature matching a threat signature, the firewall service may further comprise performing a preventive action and transmitting logging information related to the IP packet to a syslog platform.

The method for identifying intrusions to a computing system may further comprise transmitting a log query to the syslog platform and executing the syslog platform comprising receiving the logging information related to the IP packet from the firewall service, defining a new log record and receiving the log query.

The method for identifying intrusions to a computing system may further comprise receiving a log query response and determining if the log query response comprises a new log entry. Upon determining a presence of a new log entry, the method may further comprise parsing the new log entry, identifying a target client system associated with the new log entry, identifying an originating country associated with new log entry, cataloging a threat type associated with the new log entry, and updating a client system threat record associated with the target client system associated with the new log entry.

The method for identifying intrusions to a computing system may further comprise executing a portal subsystem comprising receiving a threat data request and determining if relevant data for the threat data request exists. Upon determining relevant data for the threat data exists, relevant data may be formatted for display, defining formatted data, and the formatted data may be transmitted.

The method for identifying intrusions to a computing system may further comprise executing a client API comprising transmitting the threat data request, receiving the formatted data, parsing the formatted data, defining parsed formatted data, and creating display information from the parsed formatted data.

In some embodiments, creating display information from the parsed formatted data may comprise creating at least one of a graph and a widget comprising a datum of the parsed formatted data and creating a threat observing world map comprising a datum of the parsed formatted data. Furthermore, the method may further comprise detecting a refresh event, animating a country map comprised by the threat observing world map responsive to detecting the refresh event, and displaying the threat observing world map.

In some embodiments, the method may further comprise detecting a hover of a user input device in an area of a user display associated with a country comprised by the threat observing world map, defining a detected hover and displaying the widget responsive to the detected hover. The widget may comprise a quantity of threats associated with the detected hover and a severity of the threats associated with the detected hover.

In some embodiments, the method may further comprise detecting a click of a user input device in an area of a user display associated with a country comprised by the threat observing world map, defining a detected click and modifying a display of the country within the threat observing world map associated with the detected click responsive to the detected click, defining a regional all threats detailed view. The regional all threats detailed view may comprise a quantity of threats, a date and time associated with the threats, a source of the threats, a destination IP address associated with the threats, a threat type associated with the threats, a severity of the threats, and an action associated with the threats associated with the detected click. The regional all threats detailed view may comprise displaying an arc from at least one of the country associated with the detected click and a threat source associated with the detected click to a data center associated with a threat associated with the detected click.

In some embodiments, the method may further comprise detecting a click of a user input device in a specific region of a user display, defining a detected click, and displaying a global all threats page responsive to the detected click. The global all threats page may comprise a quantity of threats, a date and time associated with the threats, a source of the threats, a destination IP address associated with the threats, a threat type associated with the threats, a severity of the threats, and an action associated with the threats comprised by the global all threats page.

In some embodiments, the method may further comprise detecting a click of a user input device in a region of a user display corresponding to a desired timeframe, defining a selected timeframe, and modifying the threat observation world map responsive to the selected timeframe. The method may also further comprise determining the parsed formatted data comprises an active threat and animating a region associated with the active threat within the threat observation world map.

In some embodiments, the method may further comprise determining all regions of the threat observation world map associated with active threats comprised by the parsed formatted data, displaying regions associated with active threats with a glowing animation, and displaying regions not associated with active threats with a static color. In some embodiments, the method may further comprise displaying a key performance indicator on the threat observation world map. In some embodiments, the method may further comprise displaying a list of the most potentially damaging threats. In some embodiments, the method may further comprising displaying a list of sources from which the most threats originate.

Embodiments of the present invention are also related to a computer program that is executable on a user device and operable to display information on a user display, the computer program being configured to transmit a threat data request, receive formatted data, parse the formatted data, defining parsed formatted data, create display information from the parsed formatted data, create at least one of a graph and a widget comprising a datum of the parsed formatted data, create a threat observing world map comprising a datum of the parsed formatted data, and display the threat observing world map on the user display. The computer program may further be configured to detect a hover of a user input device in an area of the user display associated with a country comprised by the threat observing world map, defining a detected hover and display the widget responsive to the detected hover. The widget may comprise a quantity of threats associated with the detected hover and a severity of the threats associated with the detected hover.

In some embodiments, the computer program may be further configured to detect a click of a user input device in a specific region of a user display, defining a detected click, and display a global all threats page responsive to the detected click. The global all threats page may comprise a quantity of threats, a date and time associated with the threats, a source of the threats, a destination IP address associated with the threats, a threat type associated with the threats, a severity of the threats, and an action associated with the threats comprised by the global all threats page.

In some embodiments, the computer program may further be configured to detect a click of a user input device in an area of a user display associated with a country comprised by the threat observing world map, defining a detected click, and modify a display of the country within the threat observing world map associated with the detected click responsive to the detected click, defining a regional all threats detailed view. The regional all threats detailed view comprises a quantity of threats, a date and time associated with the threats, a source of the threats, a destination IP address associated with the threats, a threat type associated with the threats, a severity of the threats, and an action associated with the threats associated with the detected click. The regional all threats detailed view comprises displaying an arc from at least one of the country associated with the detected click and a threat source associated with the detected click to a data center associated with a threat associated with the detected click.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1a is a schematic block diagram of a Threat Observation System (TOS) according to an embodiment of the present invention.

FIG. 1b is a schematic diagram of network areas of a TOS according to an embodiment of the present invention.

FIG. 2 is a diagram illustrating exemplary data structures of the TOS depicted in FIG. 1a.

FIG. 3 is a flowchart illustrating the steps performed by a firewall service according to an embodiment of the present invention.

FIG. 4 is a flowchart illustrating the steps performed by a system log maintenance platform according to an embodiment of the present invention.

FIG. 5 is a flowchart illustrating the steps performed by a data build service as executed by an ESB according to an embodiment of the present invention.

FIG. 6 is a flowchart illustrating the steps performed by an Automated Programming Interface (API) portal service as executed by an ESB according to an embodiment of the present invention.

FIG. 7 is a flowchart illustrating the steps performed by a portal process service as executed by an ESB according to an embodiment of the present invention.

FIG. 8 is a flowchart illustrating the steps performed by a client API according to an embodiment of the present invention.

FIGS. 9-24 are schematic representations of states of an exemplary user interface of the TOS according to an embodiment of the present invention.

FIG. 25 is a block diagram representation of a machine in the example form of a computer system according to an embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a Threat Observation System (TOS) and associated methods according to an embodiment of the present invention. Throughout this disclosure, the present invention may be referred to as a threat observation platform system, a threat observation platform, a threat observation and prevention system, a threat system, an observation system, an observation platform, a threat prevention system, a prevention system, a platform, a computer program product, a computer program, a product, a system, a device, and a method. Furthermore, the present invention may be referred to as relating to the implementation of a process for cloud-based intrusion detection and prevention. Those skilled in the art will appreciate that this terminology does not affect the scope of the invention. For instance, the present invention may just as easily relate to event data protection as applied to traditional endpoints and/or virtual systems.

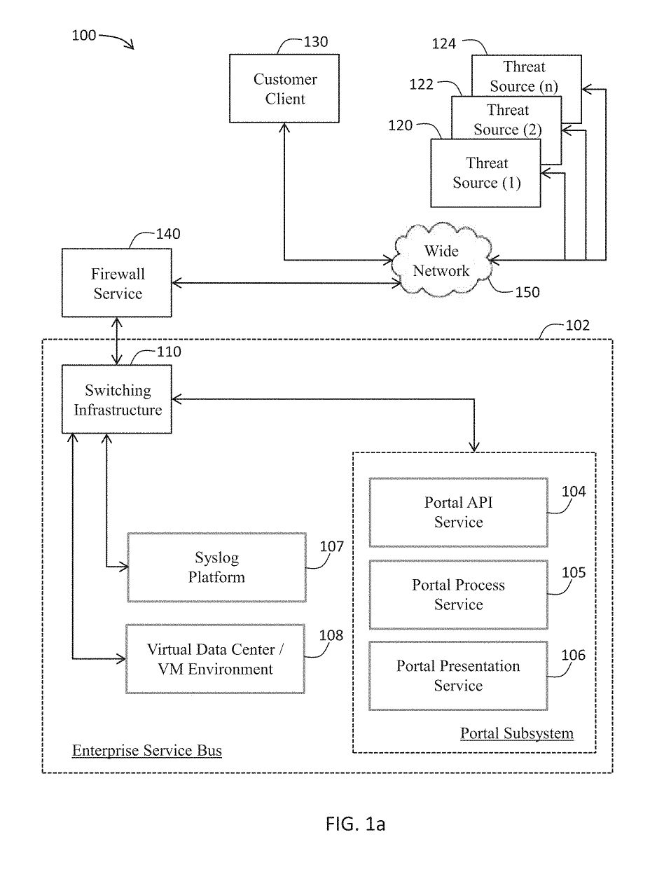

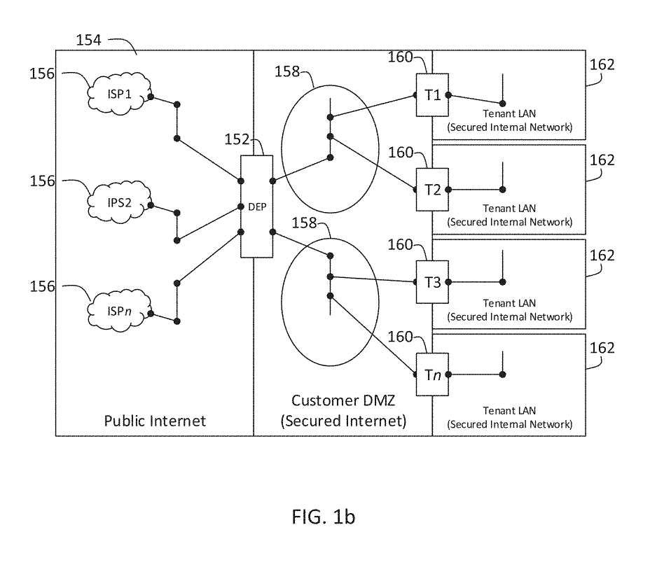

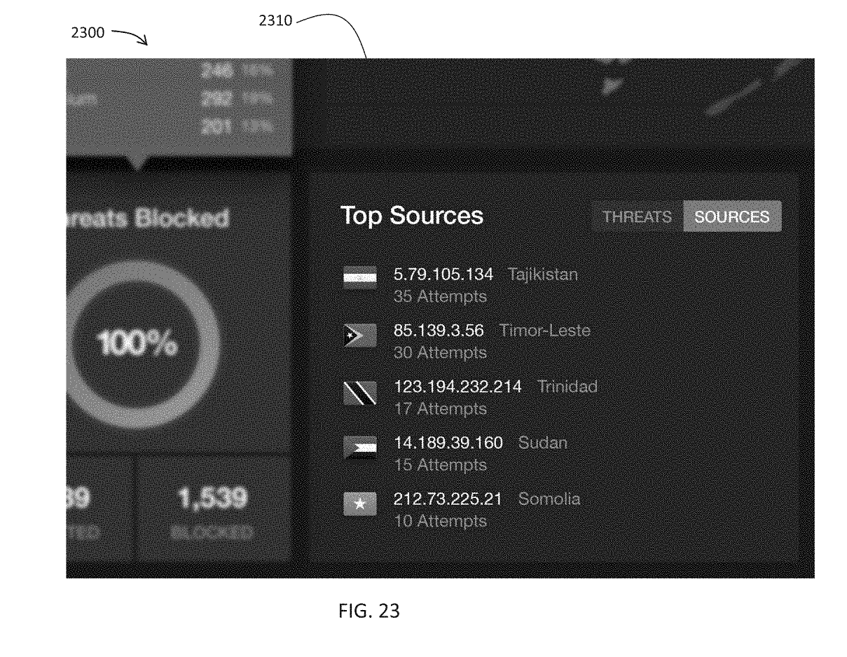

Referring to FIGS. 1-25, example methods and systems for a Threat Observation System (TOS) are described herein below. In the following description, for purposes of explanation, numerous specific details are set forth to provide a thorough understanding of example embodiments. It will be evident, however, to one of ordinary skill in the art that the present invention may be practiced without these specific details and/or with different combinations of the details than are given here. Thus, specific embodiments are given for the purpose of simplified explanation and not limitation. Some of the illustrative aspects of the present invention may be advantageous in solving the problems herein described and other problems not discussed which are discoverable by a skilled artisan.

As a matter of definition, whenever a computing device connects to the Internet, the responsible Internet service provider assigns that device a unique numerical address. This unique address, known as Internet Protocol (IP) address, identifies that device on the network so that the device can request and receive information. When the device initiates a data request, such as clicking on a link in the device's Web browser, the request travels across the Internet in the form of data packets, known as IP packets, that are stamped with the device's IP address. Generally speaking, transmission of large amounts of data typically involves disassembly of those data into small IP packets, which are sent independently to the destination address and then reassembled at the receiving end.

Referring now to FIG. 1a, the Threat Observation System (TOS) 100 according to an embodiment of the present invention will now be discussed in greater detail. An embodiment of the invention, as shown and described by the various figures and accompanying text, provides a TOS 100 that may implement an automated method of advantageously generating and displaying real-time reports of security breaches perpetrated against cloud-based computing systems. For example, and without limitation, the TOS 100, according to an embodiment of the present invention, may include a Firewall Service 140, which may be in data communication with a Customer Client 130, some number of Threat Sources 120, 122, 124, and an Enterprise Service Bus (ESB) 102. As a matter of definition, an enterprise service bus (ESB) is a software architecture model used for designing and implementing communication between mutually interacting software applications in a service-oriented architecture (SOA). The Customer Client 130, Threat Sources 120, 122, 124, and ESB 102 each may be coupled to the Firewall Service 140 using a wide area network 150 such as the Internet. The Firewall Service 140 also may have access to various third-party security data sources through third-party data server(s) (not shown) and/or through the Internet 150 directly.

For example, and without limitation, the Customer Client 130 may comprise a web browser and a communication application. “Web browser” as used herein includes, but is not limited to, any application software or program (including mobile applications) designed to enable users to access online resources and conduct trusted transactions over a wide network such as the Internet. “Communication” as used herein includes, but is not limited to, electronic mail (email), instant messaging, mobile applications, personal digital assistant (PDA), a pager, a fax, a cellular telephone, a conventional telephone, television, video telephone conferencing display, other types of radio wave transmitter/transponders and other forms of electronic communication. For example, and without limitation, the Customer Client 130 may be configured to execute web applications designed to function on any cross-platform web server running Apache, MySQL, and PHR. Those skilled in the art will recognize that other forms of communication known in the art are within the spirit and scope of the present invention.

A typical user of a Customer Client 130 may be a consumer of applications hosted not at the Client 130 but instead on some cloud server or enterprise system that services data requests from the Customer Client 130. Through normal business and/or personal interaction with the cloud, confidential information present on the Customer Client 130, such as social security numbers, personal identification information, and system access passwords, may be at risk of unauthorized exposure.

The Firewall Service 140 may comprise a processor that may accept and execute computerized instructions, and also a data store which may store data and instructions used by the processor. More specifically, the processor may be configured in data communication with the Customer Client 130, some number of Threat Sources 120, 122, 124, and the ESB 102. For example, and without limitation, the processor may be in data communication with one or more of the external computing resources 102, 120, 122, 124, 130, 140 through a direct connection and/or through a network connection 150.

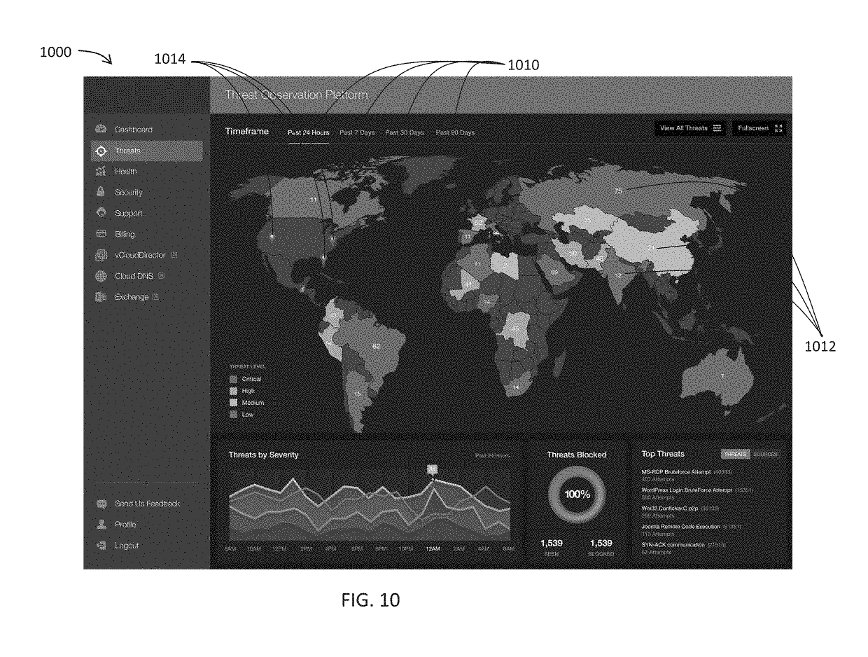

Continuing to refer to FIG. 1a, the ESB 102 may comprise one or more data centers (for example, and without limitation, see data centers 1014 as illustrated in FIGS. 10, 12, and 15), one or more of which may include a Switching Infrastructure 110 that may be configured in data communication with the Firewall Service 140, and that may operate to route data among the Firewall Service 140 and one or more of a Portal Subsystem, a Syslog Platform 107, and a Virtual Data Center/VM environment 108. For example, and without limitation, the Portal Subsystem may comprise a Portal API Service 104, a Portal Process Service 105, and a Portal Presentation Service 106. Although each of these logical components 104, 105, 106, 107, and 108 may be executed by a server, either dedicated or shared, and comprising local storage, a skilled artisan will recognize that data storage may alternatively, or in addition, be implemented as one or both of server-based storage and cloud storage.

Exemplary operations of the Firewall Service 140, Portal API Service 104, Portal Process Service 105, Portal Presentation Service 106, Syslog Platform 107, Virtual Data Center/VM Environment 108, and Customer Client 130 are described individually in greater detail below. Those skilled in the art will appreciate, however, that the present invention contemplates the use of computer instructions that may perform any or all of the operations involved in intrusion detection and prevention, including monitoring, auditing, data integrity assessment, activity pattern analysis, and reporting. The disclosure of computer instructions that include Firewall Service 140 instructions, Portal API Service 104 instructions. Portal Process Service 105 instructions, Portal Presentation Service 106 instructions, Syslog Platform 107 instructions, Virtual Data Center/VM Environment 108 instructions, and Customer Client 130 instructions is not meant to be limiting in any way. Those skilled in the art will readily appreciate that stored computer instructions may be configured in any way while still accomplishing the many goals, features and advantages according to the present invention.

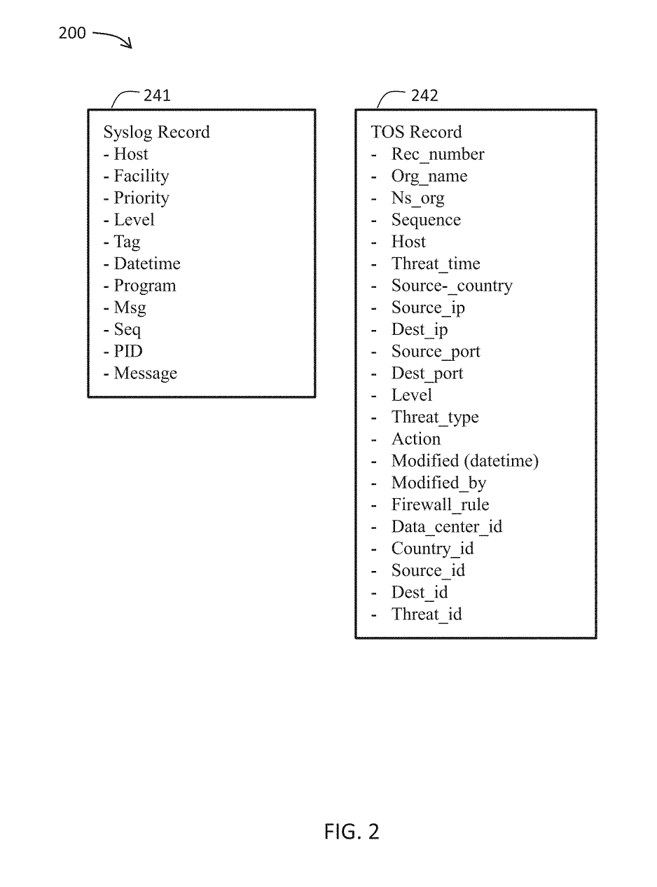

The Firewall Service 140 also may be configured execute software applications designed to monitor attempts to electronically access (for example, and without limitation, read and/or write) data on the Customer Client 130. The Firewall Service 140 also may be configured to record some or all of the results of such monitoring to a storage service, such as the Syslog Platform 107, for subsequent retrieval and manipulation. For example, and without limitation, attempts to access the Customer Client 130 may originate from one or more Threat Sources 120, 122, 124 that are also configured in data communication with the cloud and, therefore, with both the Customer Client 130 and the Firewall Service 140. In the event of an unauthorized access attempt by one of the Threat Sources 120, 122, 124, the Firewall Service 140 may capture data that is pertinent to the attempt (e.g., data/time of the attempt, identifier of the source), and may write those data to the Syslog Platform 107. The embodiment of Syslog Record 241 illustrated in FIG. 2 shows example structures of data objects that may be pertinent to an attempt by an external source to access data on the Customer Client 130.

Predictably, given the volume and speed of access requests serviced by a cloud or enterprise, firewall applications known in the art typically generate a deluge of logging information that must be monitored for traffic, both permitted and denied, in order to spot new malicious activity and/or to expose the use of a vulnerable port. Even crude log-viewing tools used by a human auditor may require augmentation of raw log data, such as the illustrated Syslog Record 241, to facilitate display of those data in a form that aids human understanding, Continuing to refer to FIG. 2, exemplary data structures augmented for manipulation by the TOS 100 are shown as TOS Record 242.

Referring now to FIG. 1b, an exemplary implementation of a TOS is presented. The TOS may comprise a datacenter enforcement point (DEP) 152 that is the interface between the public Internet 154, that is, the Internet that is not protected by the TOS, and the remainder of the TOS. The DEP 152 may be positioned in communication with any number of Internet service providers (ISPs) 156 so as to connect the TOS with the Internet 154. The DEP may further be in communication with one or more Public IP spaces 158, which may be understood as a wide-area network (WAN) that is protected by the DEP 152 against potential threats. The Public IP spaces 158 may further be in communication with one or more local-access networks (LANs) 162, each being protected by a LAN firewall 160, which may communicate with the Internet 154 via the Public IP spaces 158 and the DEP 152.

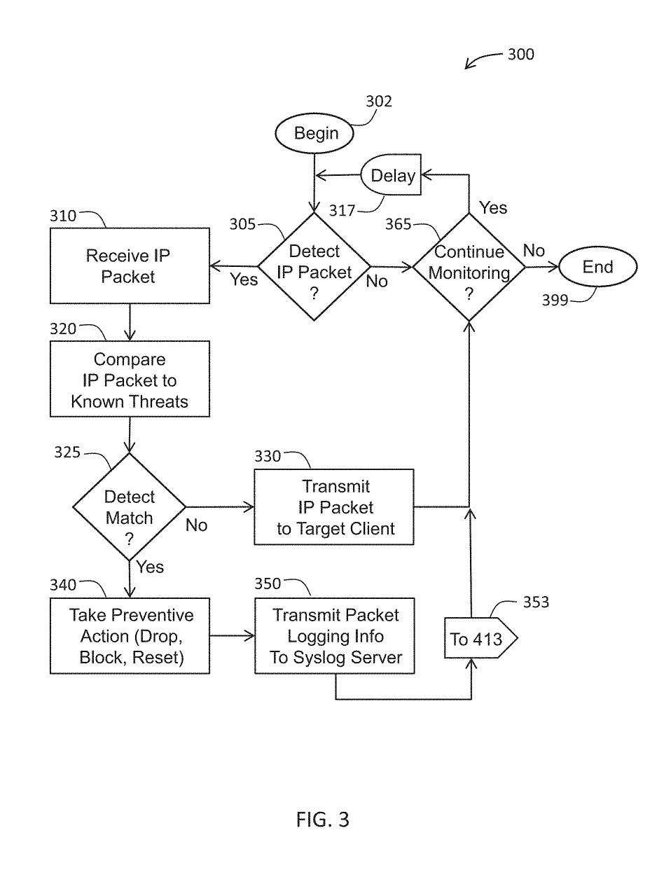

Referring now to FIG. 3, and continuing to refer to FIG. 1a, an exemplary system and associated method 300 for detecting cloud-based threats using the Firewall Service 140 according to an embodiment of the present invention are now discussed in detail. From the beginning at Block 302, the Firewall Service 140 may monitor access requests made of the Customer Client 130 (Block 305). The access request may arrive at the Firewall Service 140, for example, and without limitation, in the form of an IP Packet. If the Firewall Service 140 does not detect such an IP Packet at Block 305, the process may determine if monitoring of requests for served resources (such as the Customer Client 130) is to be continued (Block 365). If not, the process may end at Block 399. If so, then after a system-defined (or, alternatively, user-defined) delay at Block 317, the Firewall Service 140 may repeat the check for incoming IP Packets (Block 305).

If the Firewall Service 140 does detect an IP Packet targeting the Customer Client 130 at Block 305, the process may receive the IP Packet (Block 310) and may determine if the IP Packet matches the signature of known threats (Block 320). If no match is detected at Block 325, then the Firewall Service 140 may allow the IP Packet to transit to the Customer Client 130 (Block 330) as requested before returning to request monitoring mode (Blocks 365, 399, 317). If, however, the IP Packet is recognized by the Firewall Service 140 as a threat at Block 325, then the Firewall Service 140 process may take preventive action (Block 340). For example, and without limitation, the Firewall Service 140 may be configured to choose among dropping the request, blocking the request, and/or resetting the request channel. Furthermore, at Block 350, the Firewall Service 140 may transmit logging information related to the threatening IP Packet to the Syslog Platform 107 (Block 353) before returning to request monitoring mode (Blocks 365, 399, 317). For example, and without limitation, the data structure of the transmitted logging information may comprise some or all of the fields illustrated in Syslog Record 241 from FIG. 2.

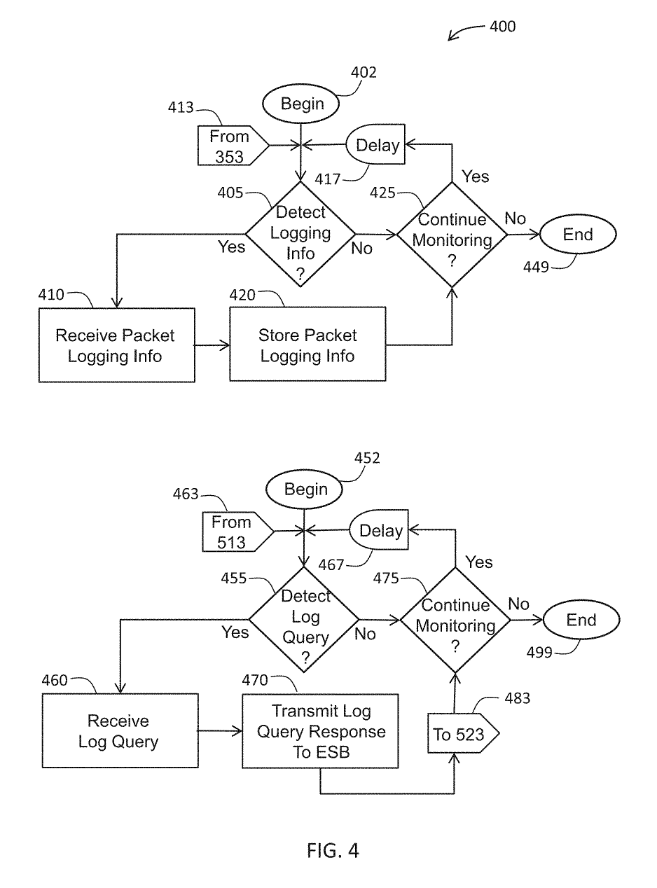

Referring now to FIG. 4, and continuing to refer to FIGS. 1 and 2, an exemplary system and associated method 400 for storing log information for cloud-based threats using the Syslog Platform 107 according to an embodiment of the present invention are now discussed in detail. From the beginning at Block 402, the Syslog Platform 107 may monitor for arrival of logging information (Block 413) from the Firewall Service 140 (Block 405).

The logging information may arrive at the Syslog Platform 107, for example, and without limitation, in the form of a Syslog Record 241. If the Syslog Platform 107 does not detect such logging information at Block 405, the process may determine if monitoring for incoming logging information is to be continued (Block 425). If not, the process may end at Block 449. If so, then after a system-defined (or, alternatively, user-defined) delay at Block 417, the Syslog Platform 107 may repeat the check for incoming logging information (Block 405). If the Syslog Platform 107 does detect logging information arriving (Block 413) from the Firewall Service 140 at Block 405, the process may receive the IP Packet (Block 410) and may store the logging information for subsequent manipulation and analysis (Block 420) before returning to request monitoring mode (Blocks 425, 449, 417).

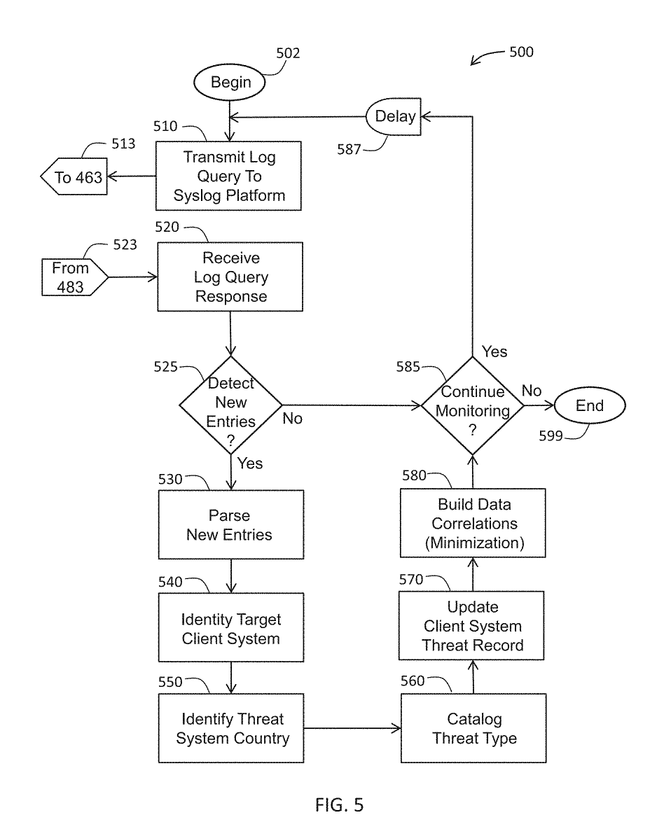

Referring now to FIG. 5, and continuing to refer to FIGS. 1 and 2, an exemplary system and associated method 500 for retrieving and augmenting logging information on cloud-based threats using the ESB 102 according to an embodiment of the present invention are now discussed in detail. From the beginning at Block 502, the ESB 102 may transmit a log query to the Syslog Platform 107. Referring additionally to FIG. 4, from the beginning at Block 452, the Syslog Platform 107 may monitor for arrival of a log query (Block 463) from the ESB 102 (Block 455). If the Syslog Platform 107 does not detect such a log query at Block 455, the process may determine if monitoring for incoming queries is to be continued (Block 475). If not, the process may end at Block 499. If so, then after a system-defined (or, alternatively, user-defined) delay at Block 467, the Syslog Platform 107 may repeat the check for incoming log queries (Block 455). If the Syslog Platform 107 does detect a log query arriving (Block 463) from the ESB 102 at Block 455, the process may receive the log query (Block 460) and may respond (Block 483) with the results of the query (e.g., a Syslog Record 241) for subsequent manipulation and analysis (Block 470) before returning to query monitoring mode (Blocks 475, 499, 467).

Referring again to FIG. 5, the query results returned by the Syslog Platform 107 (Block 523) may be received by the ESB 102 at Block 520 for analysis. If the ESB 102 does not detect new log entries since the last check of the Syslog Platform 107 (Block 525), the process may determine if querying process is to be continued (Block 585). If not, the process may end at Block 599. If so, then after a system-defined (or, alternatively, user-defined) delay at Block 587, the ESB 102 may transmit a fresh query of the Syslog Platform 107 (Block 510).

If, at Block 525, the ESB 102 does detect new log entries since the last check of the Syslog Platform 107, the process may parse the fields of the new entries (Block 530) for data that are pertinent to the advantageous presentation capabilities of the ESB 102. For example, and without limitation, analysis of the parsed fields may comprise identifying the Customer Client 130 targeted by the access attempt (Block 540), identifying the location (e.g., country) of the Threat Source 120, 122, 124 from which the access attempt originated (Block 550), and cataloging the threat type of the access attempt (Block 560). Such analysis results may be applied by the ESB 102 to update the TOS record 242 (also defined as a Threat Record) at Block 570, and to build data correlations (Block 580) to facilitate presentation of observed threats as described in detail below, before returning to attempt data monitoring mode (Blocks 585, 599, 587). For example, and without limitation, TOS records 242 and/or built data correlations from Block 580 may be stored to the Virtual Data Center/VM Environment 108.

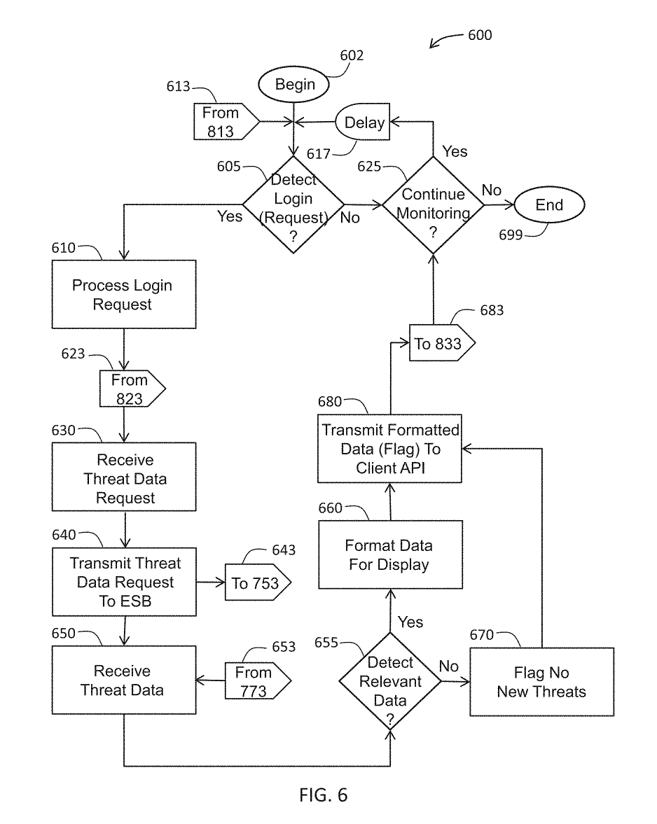

Referring now to FIG. 6, and continuing to refer to FIGS. 1 and 2, an exemplary system and associated method 600 for using the ESB 102 to provide data advantageously formatted for real-time presentation of cloud-based threats according to an embodiment of the present invention are now discussed in detail. From the beginning at Block 602, the API Portal Service 104 of the ESB 102 may monitor for arrival of a login request (Block 613) from the Customer Client 130 (Block 605). If the API Portal Service 104 does not detect such a login request at Block 605, the process may determine if monitoring for incoming threat observation service is to be continued (Block 625). If not, the process may end at Block 699. If so, then after a system-defined (or, alternatively, user-defined) delay at Block 617, the API Portal Service 104 may repeat the check for incoming login requests (Block 605). If the API Portal Service 104 does detect a login request arriving (Block 613) from the Customer Client 130 at Block 605, the process may receive and process the login request (Block 610). Upon successful login, the API Portal Service 104 may check for (Block 623) and receive from the Customer Client 130 a threat data request (Block 630). At Block 640, the API Portal Service 104 may then forward the threat data to the ESB for processing (Block 643).

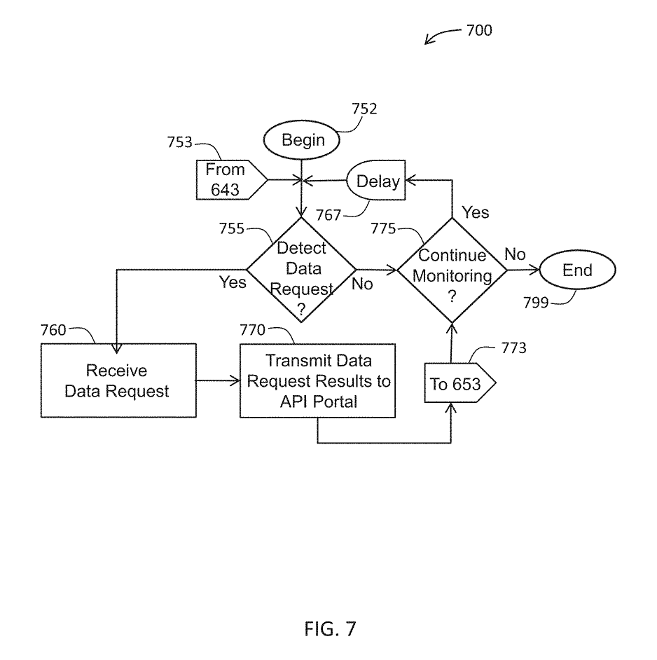

Referring now to FIG. 7, from the beginning at Block 752, the Portal Process Service 105 of the ESB 102 may monitor for arrival of a threat data request (Block 753) from the API Portal Service 104 (Block 755). If the Portal Process Service 105 does not detect such a threat data request at Block 755, the process may determine if monitoring for incoming requests is to be continued (Block 775). If not, the process may end at Block 799. If so, then after a system-defined (or, alternatively, user-defined) delay at Block 767, the Portal Process Service 105 may repeat the check for incoming threat data requests (Block 755). If the Portal Process Service 105 does detect a log query arriving (Block 753) from the ESB 102 at Block 755, the process may receive the threat data request (Block 760) and may respond (Block 773) with the requested threat data (e.g., a TOS Record 242) for subsequent formatting and display (Block 770) before returning to data request monitoring mode (Blocks 775, 799, 767).

Returning to FIG. 6, and continuing to refer to FIGS. 1 and 2, at Block 653 results returned by the Portal Process Service 105 may be received by the API Portal Service 104 at Block 650. If the API Portal Service 104 does not detect relevant data at Block 655, then the API Portal Service 104 may flag the absence of threats (Block 670) and transmit that news (Block 680) to an Application Programming Interface (API) present on the Customer Client 130 (Block 683), hereinafter referred to as the Client API. For example, and without limitation, the Client API may be implemented as a Single-Page Application (SPA), defined as a Web app that loads a single HTML page and dynamically updates that page as the user interacts with the app. SPAs may use AJAX and HTML5 to create fluid and responsive Web apps, without constant page reloads. Minimization of page reloading means much of the interface processing described in detail below occurs on the client side, in JavaScript, therefore advantageously countering attempts by intruders to “sniff” packets that would otherwise be exchanged between the client and outside servers. For additional security, the Client API may comprise encrypted code embedded in the client side browser.

If the API Portal Service 104 does detect relevant data at Block 655, then the Portal Presentation Service 106 may format the threat data for display (Block 660) before the API Portal Service 104 may transmit the formatted threat data (Block 680) to the Client API (Block 683). At Block 623, the process may determine if monitoring for incoming requests (logins) is to be continued (Block 625). If not, the process may end at Block 699. If so, then after a system-defined (or, alternatively, user-defined) delay, the API Portal Service 104 may repeat the check for incoming logins/data requests (Block 605) and continue process 600 as described above.

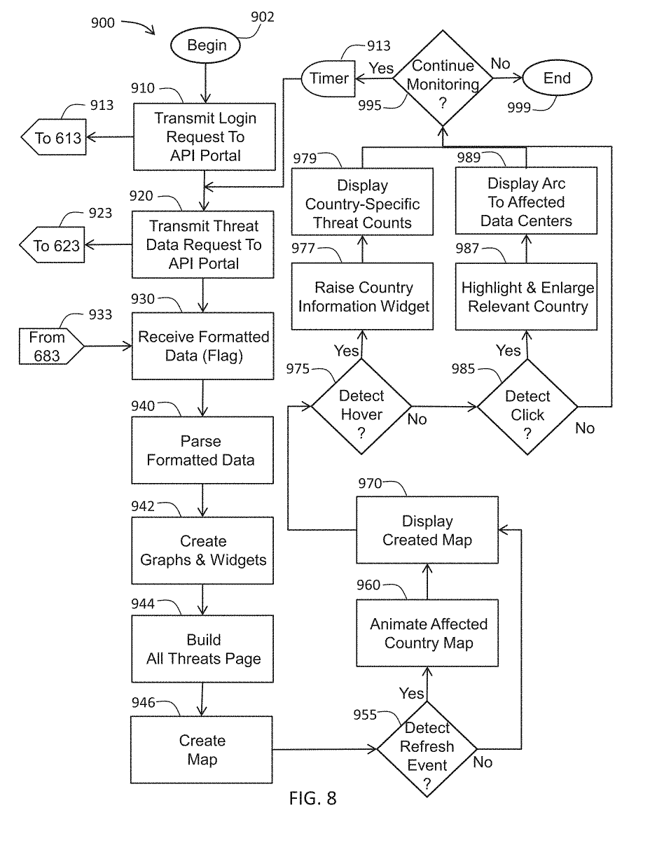

Referring now to FIG. 8, and continuing to refer to FIGS. 1 and 2, an exemplary system and associated method for requesting, retrieving, and displaying real-time threat observation information on dynamic displays using the Customer Client 130 according to an embodiment of the present invention are now discussed in detail. From the beginning at Block 902, the Client API may transmit a login request (Block 910) to the API Portal Service 104 (Block 913), Upon successful login (as described above at Block 613 of FIG. 6), the Client API may transmit a threat data request (Block 920) to the API Portal Service 104 (Block 923). The formatted threat data results returned by the API Portal Service (Block 933) may be received by the Client API at Block 930 for display generation. For example, and without limitation, the process may parse the formatted threat data (Block 940) as input to creation of graphs and widgets (Block 942), building of an all threats page (Block 944), and creation of a threat observing world map (Block 946). If, at Block 955, the Client API does not detect a refresh event at an input device, then the process may operate to display the created map (Block 970). If, however, the Client API does detect a refresh event at Block 955, then the process may animate the affected country map (Block 960) before operating to display the created map (Block 970).

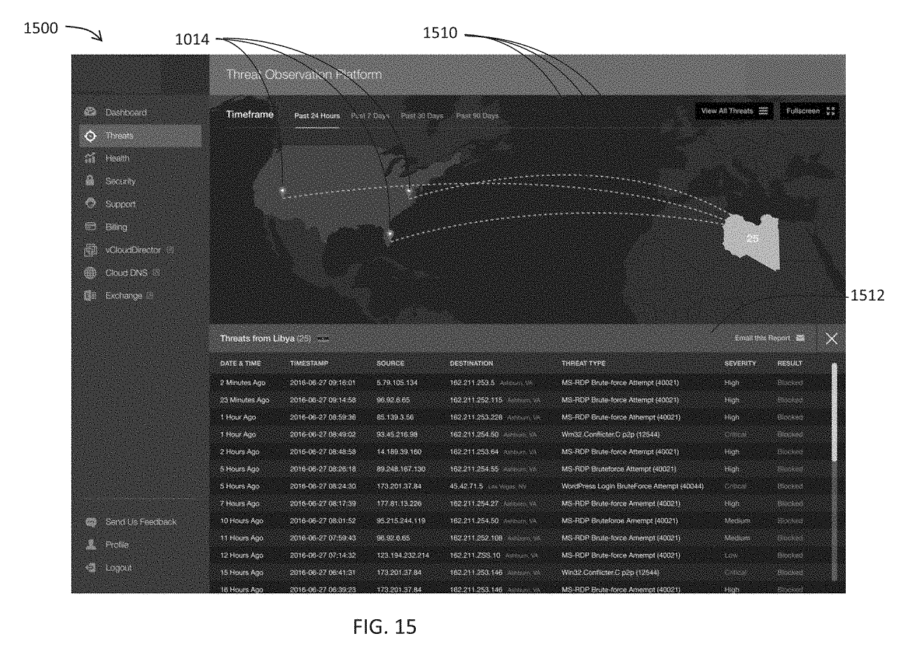

A user of the Customer Client 130 may use various input devices to interact with the dynamic map created and displayed at Block 970. For example, and without limitation, if the Client API detects a hover (Block 975) using a mouse or similar-featured input device, the Client API may raise a Country Information widget to highlight the country relevant to the targeted threat (Block 977), and then may raise a Country Information widget to display the relevant threat (Block 979). Also for example, and without limitation, if the Client API detects a click (Block 985) using a mouse or similar-featured input device, the Client API may highlight and enlarge the relevant country (Block 987) and then, at Block 989, display an arc from the country and/or threat source (see also 1510 at FIG. 15) to the affected data center(s) (see also 1014 at FIG. 15).

The Client API process 900 may continue to loop as long as the user chooses to continue monitoring incoming threats (Block 995). If the user elects to stop displaying observed threats, the process may end at Block 999. If not, then after a timed delay at Block 913, the Client CLI may transmit a fresh request for threat data (Block 920) to be used to update the dynamic threat observation displays, as described in detail below. For example, and without limitation, the timed delay may be chosen such that the perceived pause between display refreshes does not compromise the real-time responsiveness of the TOS 100 (e.g., every 5 seconds or, in any event, multiple evenly-spaced refreshes per minute).

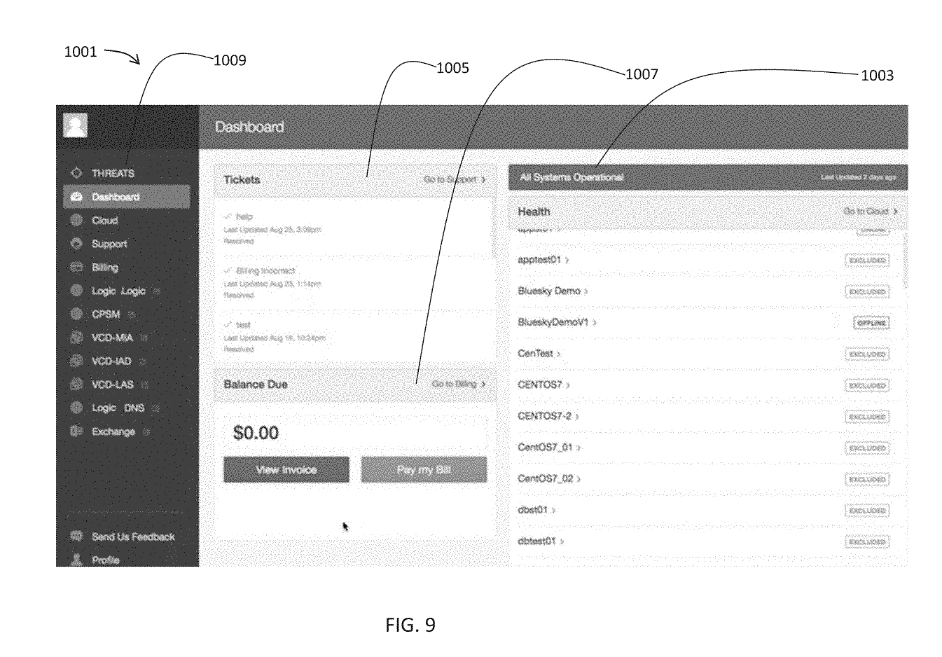

Referring now to FIG. 9, and continuing to refer to FIGS. 1 and 2, an exemplary view rendered by the TOS 100 shows a CLI API Dashboard view. For example, and without limitation, once logged in to the Client API on the Customer Client 130, a user may be presented with a dashboard 1001 from which a user may monitor the health status 1003 of all systems of the user's enterprise. For example, and without limitation, the dashboard 1001 may be configured to launch administrative activities, such as viewing invoices and paying bills 1007 for intrusion detection and/or prevention services, and such as opening trouble tickets 1005 for services support attention. Also for example, and without limitation, the dashboard 1001 may be configured to allow the user to select ‘Threats’ 1009 from a sidebar to navigate to a snapshot view of the Threat Observation Platform (TOP).

Referring now to FIG. 10, and continuing to refer to FIGS. 1 and 2, an exemplary view rendered by the TOS 100 shows a Threat Observation Platform (TOP) view. For example, and without limitation, all of the information in the TOP view 1000 may be dynamic, and the user may receive the most up to date information as soon as the page loads. At a glance, the user may advantageously and easily see current threat levels, quantity and origins, severity, top threats and sources, and threats blocked, as described in more detail below.

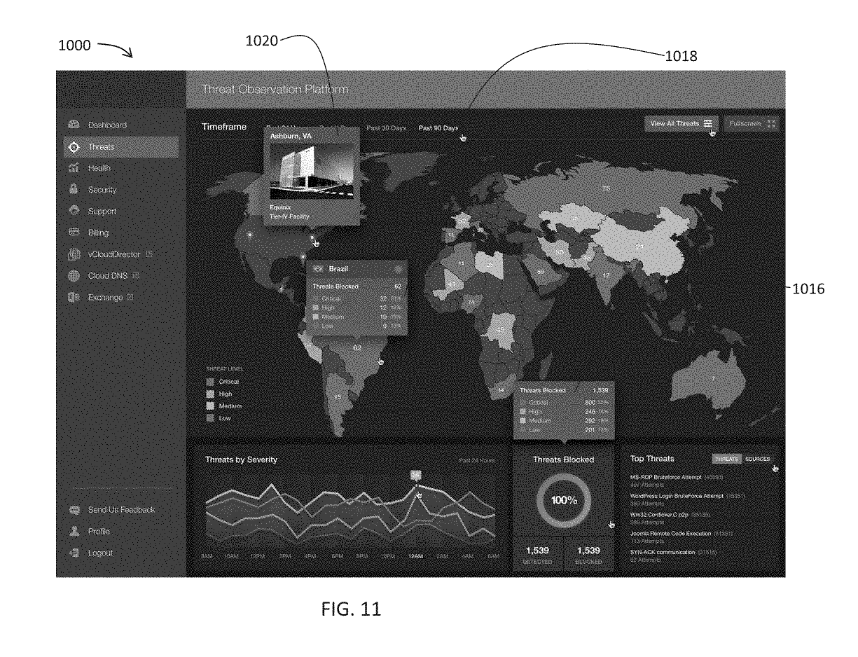

Referring now to FIG. 11, and continuing to refer to FIGS. 1 and 2, an exemplary view rendered by the TOS 100 shows an exploded TOP View 1000. For example, and without limitation, the TOP view 1000 allows a user to quickly and easily access all of the features and information provided by the Threat Observation Platform of FIG. 10. Core Features include the following (as described in more detail below):

Timeframe view

Dynamic data refresh

Report downloads

Threat Level

Threat Origin 1012

Threats by Severity w/24 hour timeline 1010

Threats Blocked and details

Top Threats

Top Threats Source

Full screen view for monitoring

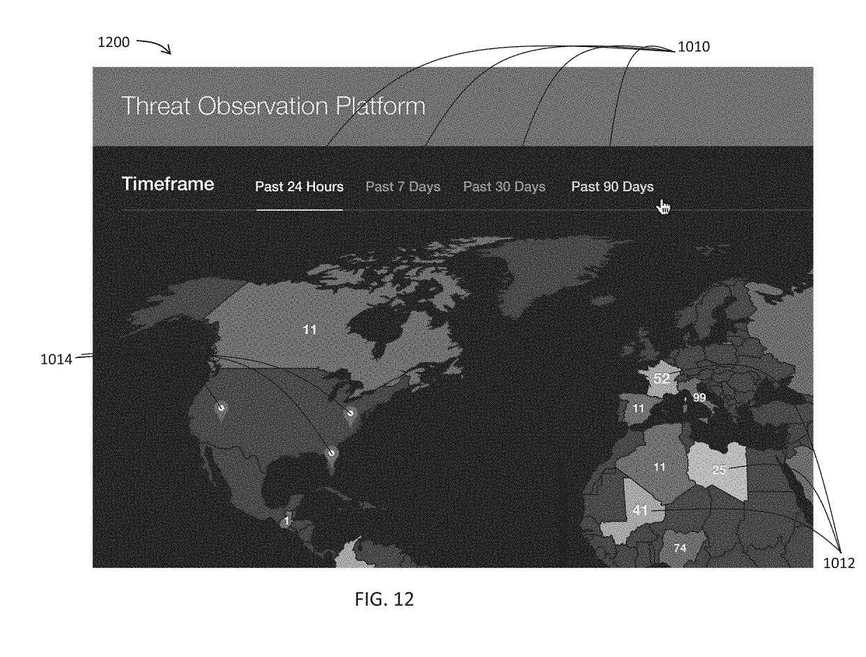

Referring now to FIG. 12, and continuing to refer to FIGS. 1 and 2, an exemplary view rendered by the TOS 100 shows a Timeframe View 1200. For example, and without limitation, the displayed Default is 24 Hours. Other options 1010 include the following:

Past 24 Hours

Past 7 Days

Past 30 Days

Past 90 Days

The illustrated display is dynamic and all reported data may update based on option selected.

Additionally, a user may manipulate an input device to click on a specific datacenter to view the popup 1020 with information about the datacenter. Further, a user may manipulate an input device to hover over a Threats Blocked section of the TOP view 1000 to display a popup 1016 with Threat Details associated with the datacenter, including quantity of threats by severity level.

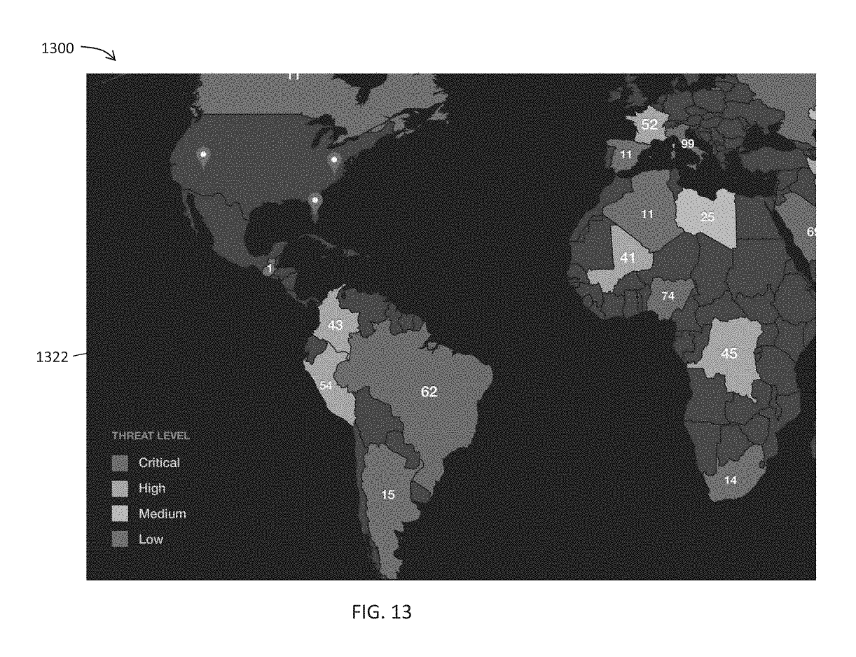

Referring now to FIG. 13, and continuing to refer to FIGS. 1 and 2, an exemplary view rendered by the TOS 100 shows a Threat Level view 1300. For example, and without limitation, a threat level may be represented using the NORAD scale 1322. Within any timeframe the threat level may advantageously be recognized by color and origin. For example, and without limitation, if the threat is currently active within any region 1012, this status may be visible with a glowing animation for fifteen (15) seconds before returning to static color.

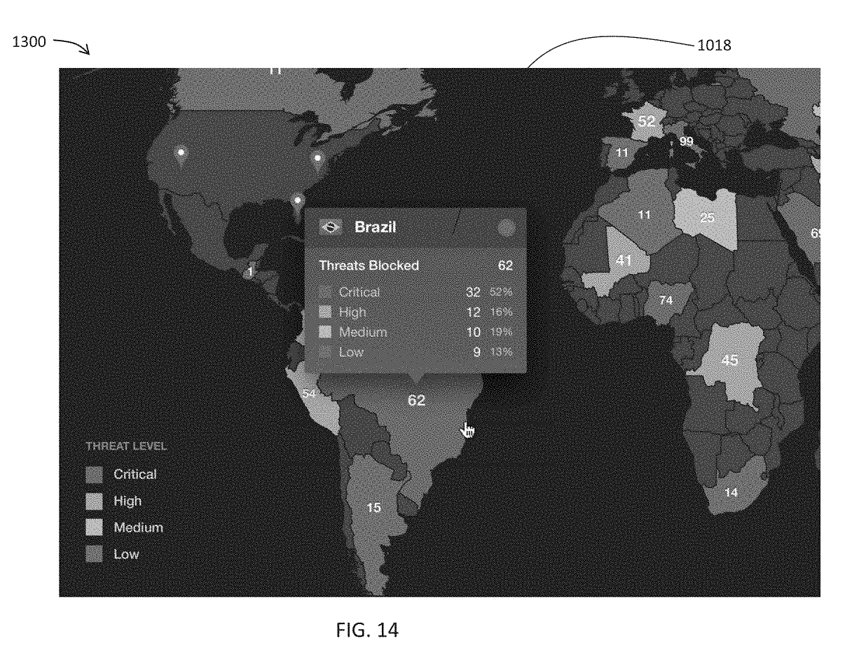

Referring now to FIG. 14, and continuing to refer to FIGS. 1 and 2, an exemplary view rendered by the TOS 100 shows an exploded Threat Level view 1300. For example, and without limitation, a user may manipulate an input device to hover over any region 1012 to view the popup 1018 with Threat Details for that region, including quantity of threats by severity level.

Referring now to FIG. 15, and continuing to refer to FIGS. 1 and 2, an exemplary view rendered by the TOS 100 shows a Threat Level—Reports view 1500. For example, and without limitation, a user may manipulate an input device to click on a specific region 1012 to view All Threats for that region. A detailed view 1512 of all threats may display the following:

Quantity of Regional Threats (Timeline based)

Date & Time

Timestamp

Source

Destination IP

Threat Type

Severity

Action

Email This Report—allows a user to email one's self, a data view (.csv) of the Regional Threats for the selected timeframe.

Select ‘X’ to return to the dashboard view.

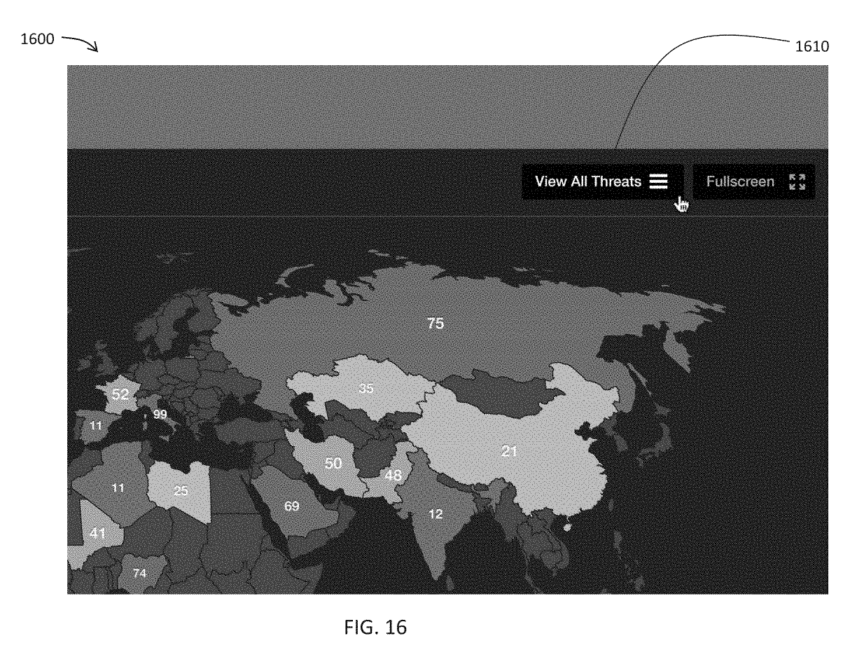

Referring now to FIG. 16, and continuing to refer to FIGS. 1 and 2, an exemplary view rendered by the TOS 100 shows a Global view 1600. For example, and without limitation, selecting View All Threats 1610 from the Global View 1600 may generate the second reporting option described in more detail below.

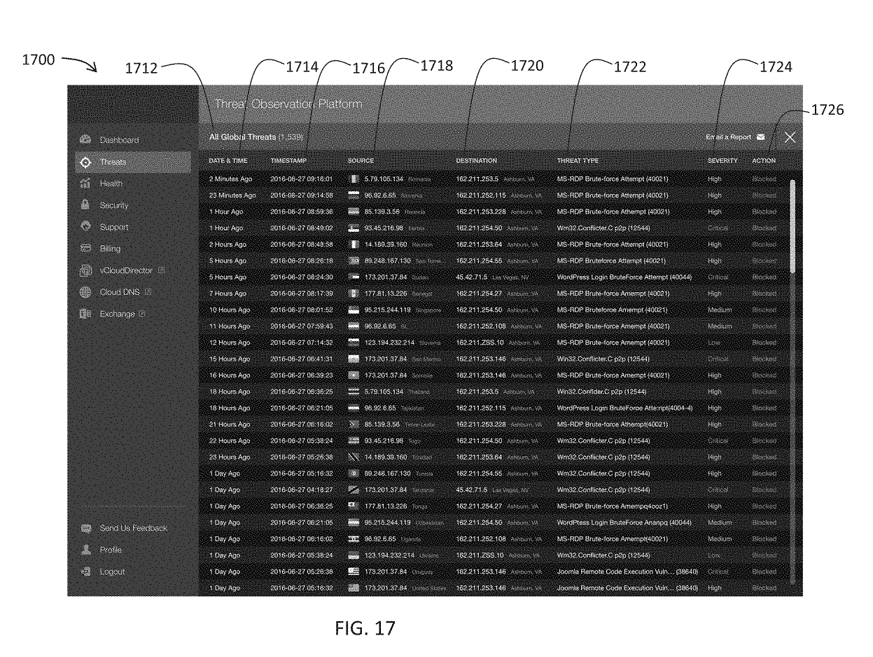

Referring now to FIG. 17, and continuing to refer to FIGS. 1 and 2, an exemplary view rendered by the TOS 100 shows a View All Threats—Detail view 1700. For example, and without limitation, selecting View All Threats from the Global View 1600 may generate one of two reporting options:

A detailed view 1700 of all threats may display the following:

Quantity of Global Threats (Timeline based) 1712

Date & Time 1714

Timestamp 1716

Source 1718

Destination IP 1720

Threat Type 1722

Severity 1724

Action 1726

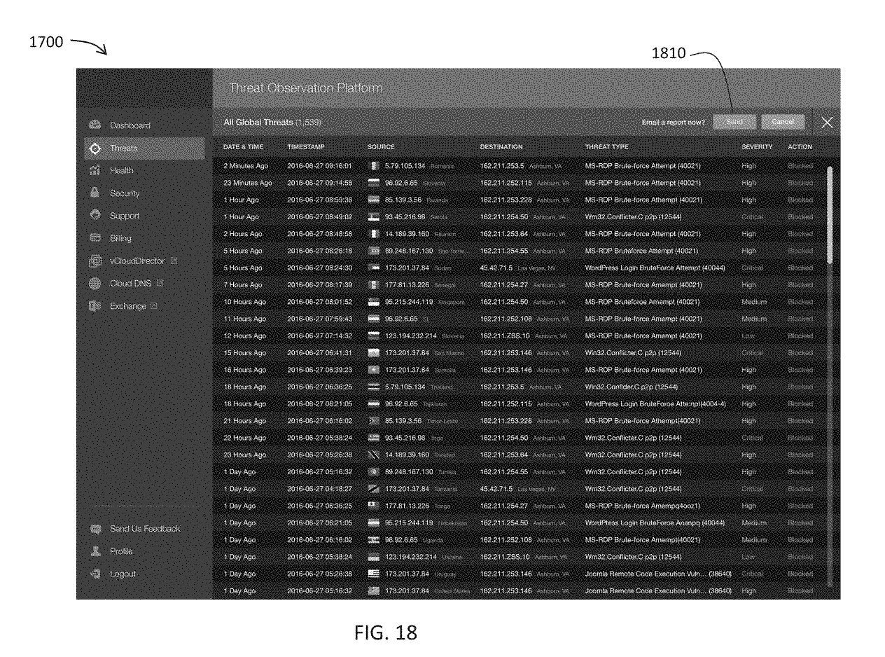

Referring now to FIG. 18, and continuing to refer to FIGS. 1 and 2, an exemplary view rendered by the TOS 100 shows an Email A Report navigation option. For example, and without limitation, selecting Email a Report 1810 from the Threats menu may allow a user to email the authorized user, a data view (.csv) of All Global Threats for the selected timeframe. The Client API may display a confirmation message when a requested email is completed. A user may be allowed to Select ‘X’ to return to the Dashboard view 1001.

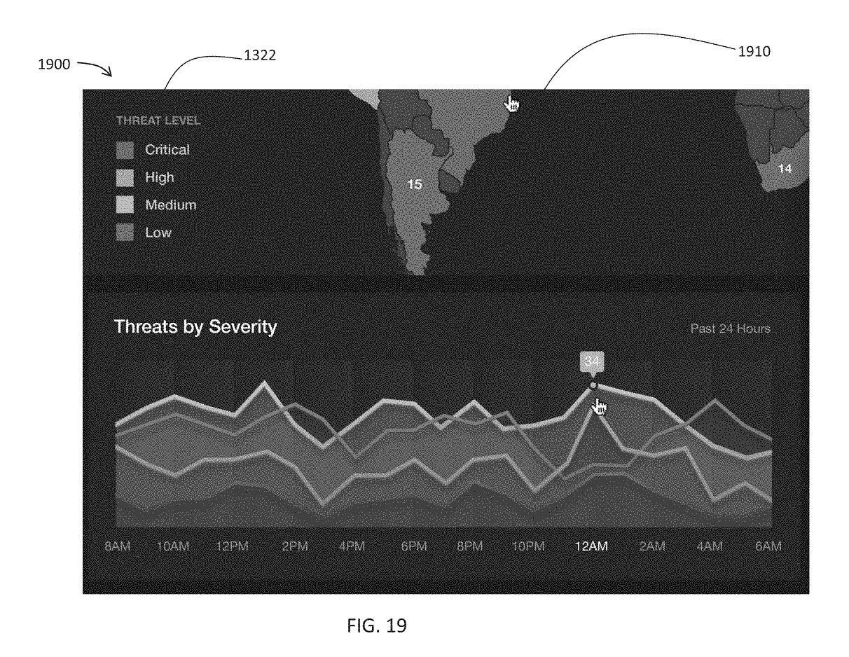

Referring now to FIG. 19, and continuing to refer to FIGS. 1 and 2, an exemplary view rendered by the TOS 100 shows a Threats By Severity view 1900. For example, and without limitation, this dynamic graph display may allow a user to use an input device to hover over any point in the timeline 1910 to result in display of the quantity of threats by severity at a specific time (for example, and without limitation, within the past 24 hours).

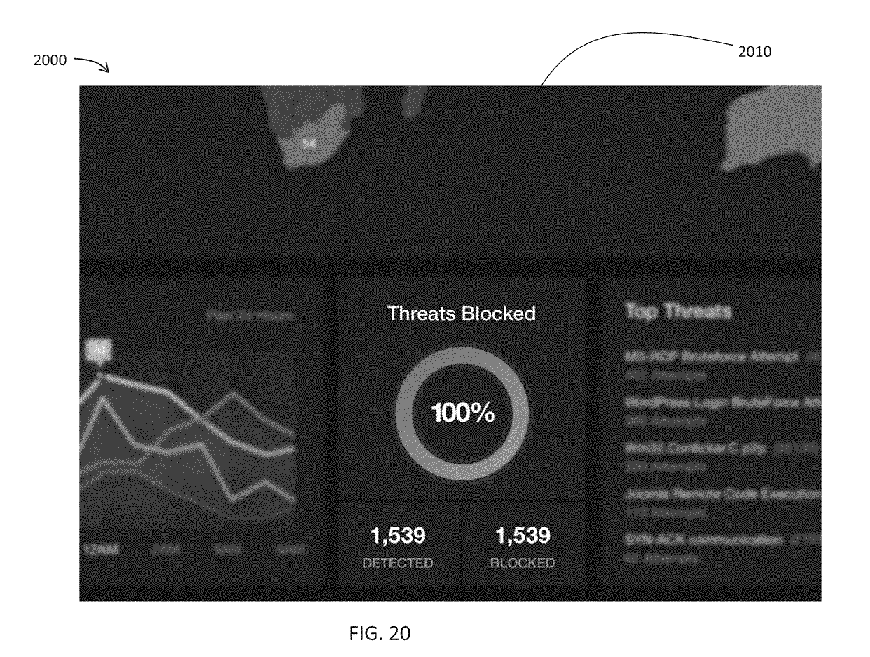

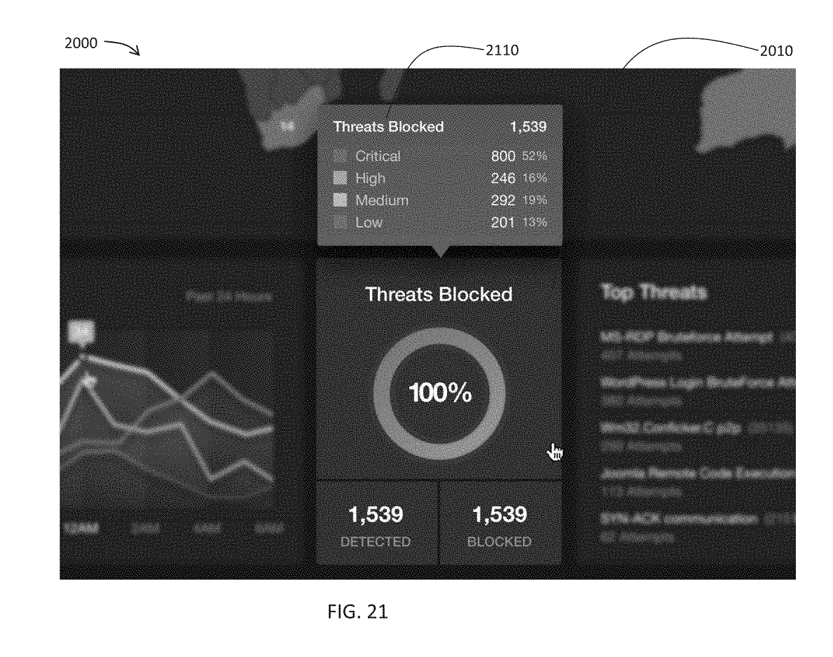

Referring now to FIG. 20, and continuing to refer to FIGS. 1 and 2, an exemplary view rendered by the TOS 100 shows a Threats Blocked view 2000. For example, and without limitation, Intrusion Detection and Intrusion Prevention may be at the core of the Threat Observation System 100. The key performance indicator (KPI) of Threats Blocked 2010 may provide the user a quick view of system performance, in any timeframe. The user may hover over the KPI to view the popup showing Threat Blocked details (as illustrated at in FIG. 21). For example, and without limitation, the popup 2110 may include a breakdown of Threat Levels and Quantities of each.

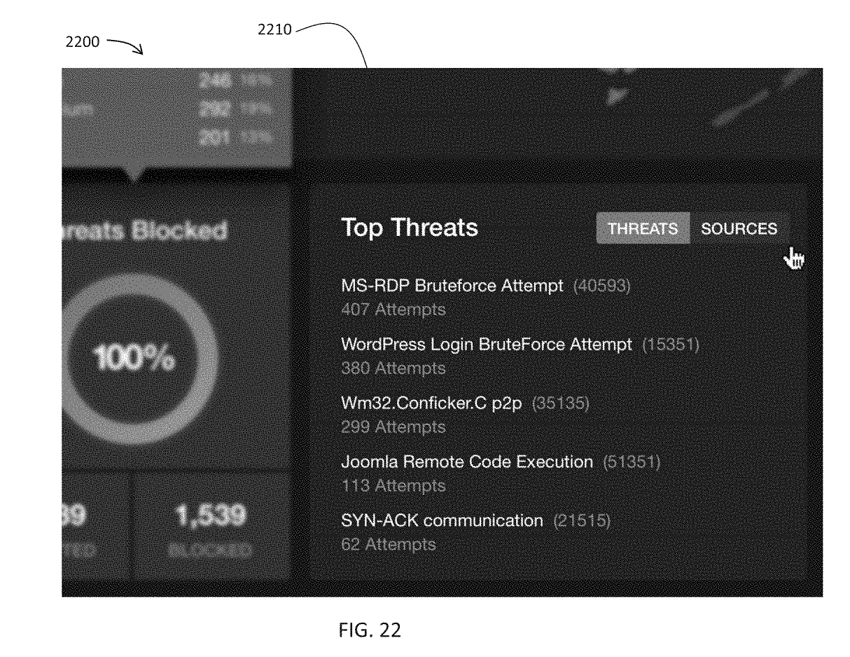

Referring now to FIG. 22, and continuing to refer to FIGS. 1 and 2, an exemplary view rendered by the TOS 100 shows a Top Threats view 2200. Referring additionally to FIG. 22, an exemplary view rendered by the TOS 100 shows a Top Sources view 2300. For example, and without limitation, within a user's selected timeframe the user may advantageously Toggle between both Most Threat Types 2210 and Most Threat Sources 2310.

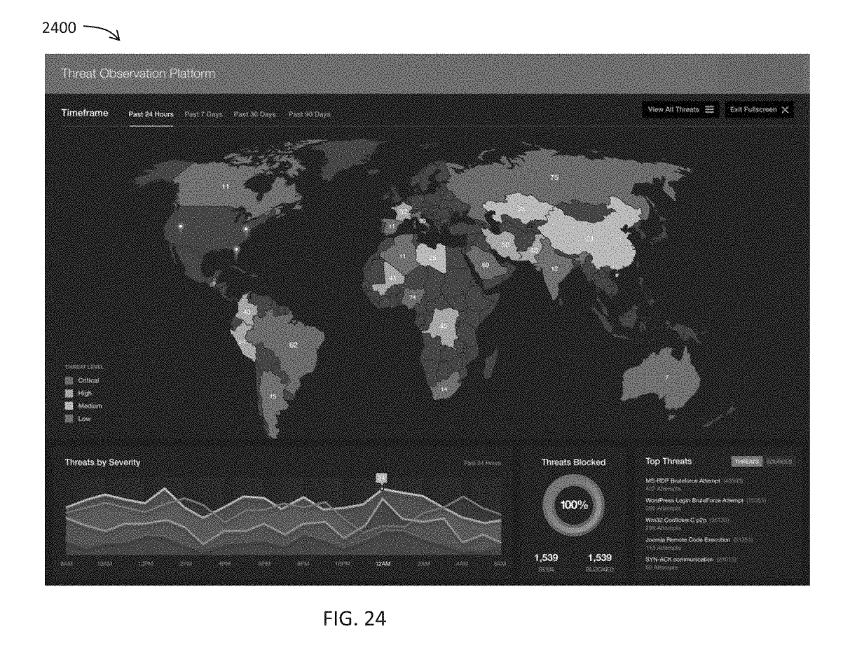

Referring now to FIG. 24, and continuing to refer to FIGS. 1 and 2, an exemplary view rendered by the TOS 100 shows a Fullscreen View 2400. For example, and without limitation, selecting Fullscreen View 2400 may allow a user to toggle between Show/Hide the side navigation bar. This advantageous feature may allow a user to display to potential customers and employees, in an attractive and communicative manner, how important security is to the user's business. For example, and without limitation, the user may display the Threat Observation Platform in the business's network operations center (NOC) or executive Conference Room.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

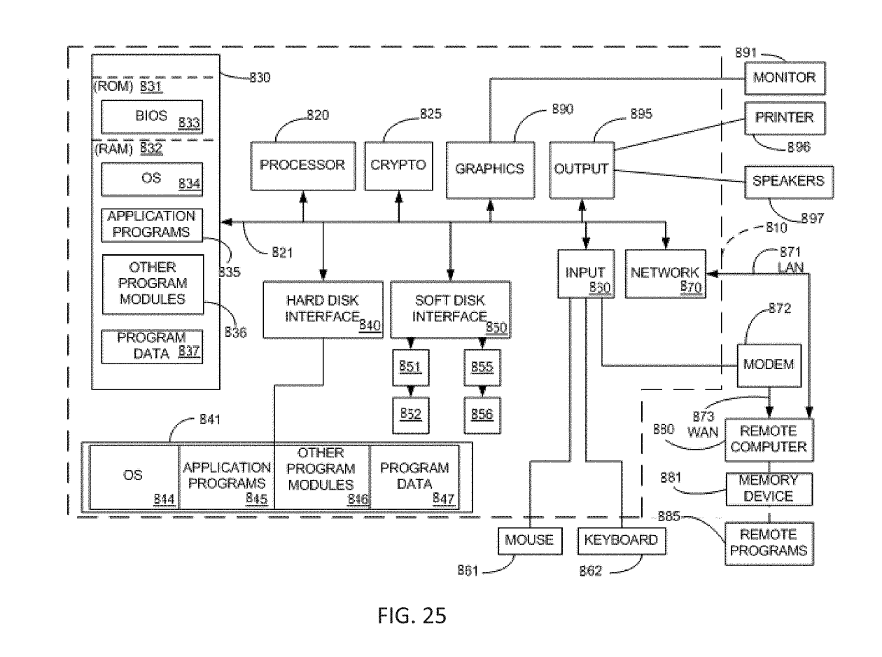

A skilled artisan will note that one or more of the aspects of the present invention may be performed on a computing device. The skilled artisan will also note that a computing device may be understood to be any device having a processor, memory unit, input, and output. This may include, but is not intended to be limited to, cellular phones, smart phones, tablet computers, laptop computers, desktop computers, personal digital assistants, etc. FIG. 25 illustrates a model computing device in the form of a computer 810, which is capable of performing one or more computer-implemented steps in practicing the method aspects of the present invention. Components of the computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI).

The computer 810 may also include a cryptographic unit 825. Briefly, the cryptographic unit 825 has a calculation function that may be used to verify digital signatures, calculate hashes, digitally sign hash values, and encrypt or decrypt data. The cryptographic unit 825 may also have a protected memory for storing keys and other secret data. In other embodiments, the functions of the cryptographic unit may be instantiated in software and run via the operating system.

A computer 810 typically includes a variety of computer readable media. Computer readable media can be any available media that can be accessed by a computer 810 and includes both volatile and nonvolatile media, removable and non-removable media. By way of example, and not limitation, computer readable media may include computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer 810. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 25 illustrates an operating system (OS) 834, application programs 835, other program modules 836, and program data 837.

The computer 810 may also include other removable/non-removable, volatile/nonvolatile computer storage media. By way of example only, FIG. 25 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives, and their associated computer storage media discussed above and illustrated in FIG. 25, provide storage of computer readable instructions, data structures, program modules and other data for the computer 810. In FIG. 25, for example, hard disk drive 841 is illustrated as storing an OS 844, application programs 845, other program modules 846, and program data 847. Note that these components can either be the same as or different from OS 833, application programs 833, other program modules 836, and program data 837. The OS 844, application programs 845, other program modules 846, and program data 847 are given different numbers here to illustrate that, at a minimum, they may be different copies. A user may enter commands and information into the computer 810 through input devices such as a keyboard 862 and cursor control device 861, commonly referred to as a mouse, trackball or touch pad. Other input devices (not shown) may include a microphone, joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a graphics controller 890. In addition to the monitor, computers may also include other peripheral output devices such as speakers 897 and printer 896, which may be connected through an output peripheral interface 895.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 25. The logical connections depicted in FIG. 25 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation. FIG. 25 illustrates remote application programs 885 as residing on memory device 881.

The communications connections 870 and 872 allow the device to communicate with other devices. The communications connections 870 and 872 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

The Threat Observation System 100, as described above, may employ an ESB architecture to provide quasi-real-time threat monitoring characterized by the following advantages over the prior art:

Affordability (cloud service logic)

Scalability (minimally invasive to enterprise systems)

Flexibility (load balancing)

Role-based access

Customer-specific views (isolated from those without a need to know)

Integrated analysis

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

That which is claimed is:

1. A method for identifying intrusions to a computing system comprising:
executing a firewall service comprising:
detecting an access request comprising an Internet Protocol (IP) packet to the computing system;
determining if the IP packet comprises a signature matching a threat signature;
upon determining the IP packet does not comprise a signature matching a threat signature, permitting the IP packet to transit to a target client associated with the IP packet; and
upon determining the IP packet comprises a signature matching a threat signature,
performing a preventive action; and
transmitting logging information related to the IP packet to a syslog platform;
transmitting a log query to the syslog platform;
executing the syslog platform comprising:
receiving the logging information related to the IP packet from the firewall service, defining a new log record; and
receiving the log query;
receiving a log query response;
determining if the log query response comprises a new log entry;
upon determining a presence of a new log entry,
parsing the new log entry;
identifying a target client system associated with the new log entry;
identifying an originating country associated with new log entry;
cataloging a threat type associated with the new log entry; and
updating a client system threat record associated with the target client system associated with the new log entry;
executing a portal subsystem comprising:
receiving a threat data request;
determining if relevant data for the threat data request exists;
upon determining relevant data for the threat data exists, formatting the relevant data for display, defining formatted data; and
transmitting the formatted data; and
executing a client API comprising:
transmitting the threat data request;
receiving the formatted data;
parsing the formatted data, defining parsed formatted data; and
creating display information from the parsed formatted data.

2. The method of claim 1 wherein creating display information from the parsed formatted data comprises:
creating at least one of a graph and a widget comprising a datum of the parsed formatted data; and
creating a threat observing world map comprising a datum of the parsed formatted data.

3. The method of claim 2 further comprising:
detecting a refresh event;
animating a country map comprised by the threat observing world map responsive to detecting the refresh event; and
displaying the threat observing world map.

4. The method of claim 2 further comprising:
detecting a hover of a user input device in an area of a user display associated with a country comprised by the threat observing world map, defining a detected hover; and
displaying the widget responsive to the detected hover.

5. The method of claim 4 wherein the widget comprises a quantity of threats associated with the detected hover and a severity of the threats associated with the detected hover.

6. The method of claim 2 further comprising:
detecting a click of a user input device in an area of a user display associated with a country comprised by the threat observing world map, defining a detected click; and
modifying a display of the country within the threat observing world map associated with the detected click responsive to the detected click, defining a regional all threats detailed view.

7. The method of claim 6 wherein the regional all threats detailed view comprises a quantity of threats, a date and time associated with the threats, a source of the threats, a destination IP address associated with the threats, a threat type associated with the threats, a severity of the threats, and an action associated with the threats associated with the detected click.

8. The method of claim 6 wherein the regional all threats detailed view comprises displaying an arc from at least one of the country associated with the detected click and a threat source associated with the detected click to a data center associated with a threat associated with the detected click.

9. The method of claim 2 further comprising:
detecting a click of a user input device in a specific region of a user display, defining a detected click; and
displaying a global all threats page responsive to the detected click;
wherein the global all threats page comprises a quantity of threats, a date and time associated with the threats, a source of the threats, a destination IP address associated with the threats, a threat type associated with the threats, a severity of the threats, and an action associated with the threats comprised by the global all threats page.

10. The method of claim 2 further comprising:
detecting a click of a user input device in a region of a user display corresponding to a desired timeframe, defining a selected timeframe; and
modifying the threat observation world map responsive to the selected timeframe,

11. The method of claim 2 further comprising:
determining the parsed formatted data comprises an active threat; and
animating a region associated with the active threat within the threat observation world map.

12. The method of claim 2 may further comprise:
determining all regions of the threat observation world map associated with active threats comprised by the parsed formatted data;
displaying regions associated with active threats with a glowing animation; and
displaying regions not associated with active threats with a static color.

13. The method of claim 2 further comprising displaying a key performance indicator on the threat observation world map.

14. The method of claim 2 further comprising displaying a list of the most potentially damaging threats.

15. The method of claim 2 further comprising displaying a list of sources from which the most threats originate.

16. A computer program that is executable on a user device and operable to display information on a user display, the computer program being configured to:
transmit a threat data request;
receive formatted data;
parse the formatted data, defining parsed formatted data;
create display information from the parsed formatted data;
create at least one of a graph and a widget comprising a datum of the parsed formatted data;
create a threat observing world map comprising a datum of he parsed formatted data; and
display the threat observing world map on the user display.

17. The computer program of claim 16 further configured to:
detect a hover of a user input device in an area of the user display associated with a country comprised by the threat observing world map, defining a detected hover; and
display the widget responsive to the detected hover;
wherein the widget comprises a quantity of threats associated with the detected hover and a severity of the threats associated with the detected hover.

18. The computer program of claim 16 further configured to:
detect a click of a user input device in a specific region of a user display, defining a detected click; and
display a global all threats page responsive to the detected click;
wherein the global all threats page comprises a quantity of threats, a date and time associated with the threats, a source of the threats, a destination IP address associated with the threats, a threat type associated with the threats, a severity of the threats, and an action associated with the threats comprised by the global all threats page.

19. The computer program of claim 16 further configured to:
detect a click of a user input device in an area of a user display associated with a country comprised by the threat observing world map, defining a detected click; and
modify a display of the country within the threat observing world map associated with the detected click responsive to the detected click, defining a regional all threats detailed view;
wherein the regional all threats detailed view comprises a quantity of threats, a date and time associated with the threats, a source of the threats, a destination IP address associated with the threats, a threat type associated with the threats, a severity of the threats, and an action associated with the threats associated with the detected click.

20. The computer program of claim 19 wherein the regional all threats detailed view comprises displaying an arc from at least one of the country associated with the detected click and a threat source associated with the detected click to a data center associated with a threat associated with the detected click.
